(19) United States
(12) Patent Application Publication
(10) Pub. No.: US 2026/0268266 A1
(43) Pub. Date: Sep. 10, 2026

(54) METHODS AND SYSTEMS FOR COORDINATION OF THIRD PARTY ITEM SHIPMENTS

(71) Applicant: Target Brands, Inc., Minneapolis, MN (US)

(72) Inventors: Matthew Michael Schlicksup, St. Anthony, MN (US); Jason Edward D'Souza, Plymouth, MN (US); Nidhi Sen, Eagan, MN (US); Andrew Rudge, Stuart, FL (US); Kayla Ann Byers, Bloomington, MN (US); Jamie Mielke, Waconia, MN (US); Sara Sipple, New Brighton, MN (US); Justin Skarhus, Minneapolis, MN (US); Matthew James Milosevich, St. Anthony, MN (US); Adam Hollenbeck, Blaine, MN (US); Nathan Foster Gaida, Big Lake, MN (US); Rimli Ghosh, Middletown, DE (US)

(21) Appl. No.: 19/074,175

(22) Filed: Mar. 7, 2025

(51) Int. Cl. G06Q 10/0835; G06Q 10/0833; G06Q 10/0834

(52) U.S. Cl. CPC G06Q 10/0835; G06Q 10/0833; G06Q 10/08345

(57) ABSTRACT

Disclosed are systems and methods for providing item shipment options to third party partner vendors for the shipment of items provided by third party partner nodes via carriers with whom the enterprise has a contract. These disclosed enterprise systems and methods include computing systems configured to: provide the third party partner vendor with carrier options and quotes based at least in part on realtime data; based on a selection of a carrier option by the third party partner vendor, generate and encode a shipping label for the item(s) of a virtual order; and, because of the encoding of the shipping label, directly receive realtime shipping status/tracking update data for the item(s) from the carriers.

### BACKGROUND

An enterprise that offers items for sale to be delivered to customers at a destination may be transported from an origin node to the destination through a line hauling system, which routes items from nodes to the destination, and in some examples, through intermediate sortation locations. The items may be transported along routes between locations via one or more carriers (for example, long haul carriers or last mile delivery (LMD) carriers). Some enterprises expand their sale offerings by acting as an online marketplace for third party partner items. Historically, contracts to perform deliveries of items from third party partner nodes have been established between a carrier service and the third party partner. This means that, in order for the enterprise to provide shipping updates to customers and to track or gather any shipping data for internal uses, any shipment status information must be forwarded from third party partners, or otherwise requested from or received from the carriers’ computer systems. This historical process, in which individual third party partners retain information regarding shipment locations and that same information is only available to the enterprise on request, decreases the efficiency with which the enterprise can process, track, and update shipping orders internally and to customers.

### SUMMARY

In general, the subject matter of this disclosure relates to an improvement in systems that provide item shipment options to third party partner vendors for the shipment of items provided by third party partner nodes via carriers with whom the enterprise has a contract. These disclosed enterprise systems and methods include computing systems configured to: provide the third party partner vendor with carrier options and quotes based at least in part on realtime data; based on a selection of a carrier option by the third party partner vendor, generate and encode a shipping label for the item(s) of a virtual order; and, because of the encoding of the shipping label, directly receive realtime shipping status/tracking update data for the item(s) from the carriers.

Accordingly, the present application describes a computing system, comprising: at least one processor; and at least one memory storing computer-executable instructions, the computer-executable instructions when executed by the at least one processor causing the computing system to: provide, from an enterprise receiving an order, at least a portion of the order to a partner vendor, the order including an item being allocated to a node associated with the partner vendor, the order having a destination associated therewith; receive a shipping quote request message from the partner vendor at an order coordination application; and provide the shipping quote request message to a carrier selection application. The instructions further cause the system to: select, at the carrier selection application, at least one shipping carrier option for shipment of the item from the node to the destination, wherein the at least one shipping carrier option is selected from among a plurality of carriers based, at least in part, on realtime data associated with the plurality of carriers, wherein each of the plurality of carriers has a plurality of predefined carrier rates maintained for use by the enterprise; determine, at the carrier selection application, a quote associated with each of the at least one shipping carrier options, each quote being based on a selected carrier rate from among the plurality of predefined carrier rates, a location of the node, and the destination; calculate, at the order coordination application, a partner vendor quote associated with each of the at least one shipping carrier options, comprising applying an adjustment to each determined quote; provide, by the order coordination application, the at least one shipping carrier options and each associated partner vendor quote to the partner vendor; and receive a responsive communication from the partner vendor. Wherein, when the responsive communication comprises a selection, by the partner vendor, of a shipping carrier of the at least one shipping carrier options, the instructions further cause the system to: send a label request to a label creation application; generate, at the label creation application, a label associated with the order; encode, at the label creation application, the label with information identifying the order as being associated with the enterprise; receive the encoded label; provide the encoded label to the partner vendor; receive, from the partner vendor, shipment data associated with shipping of the item from the node to the destination via the selected shipping carrier; and receive, directly from the selected shipping carrier, realtime shipping updates related to the encoded label.

The present application further describes a method, comprising: providing, from an enterprise receiving an order, at least a portion of the order to a partner vendor, the order including an item being allocated to a node associated with the partner vendor, the order having a destination associated therewith; receiving a shipping quote request from the partner vendor; selecting at least one shipping carrier option for shipment of the item from the node to the destination, wherein the at least one shipping carrier option is selected from among a plurality of carriers based, at least in part, on realtime data associated with the plurality of carriers, wherein each of the plurality of carriers has a plurality of predefined carrier rates maintained for use by the enterprise; determining a quote associated with each of the at least one shipping carrier options, each quote being based on a selected carrier rate from among the plurality of predefined carrier rates, a location of the node, and the destination; calculating a partner vendor quote associated with each of the at least one shipping carrier options, comprising applying an adjustment to each determined quote; providing the at least one shipping carrier options and each associated partner vendor quote to the partner vendor; receiving a responsive communication from the partner vendor; and based on the responsive communication comprising a selection, by the partner vendor, of a shipping carrier of the at least one shipping carrier options: generating, at the label creation application, a label associated with the order; encoding, at the label creation application, the label with information identifying the order as being associated with the enterprise; providing the encoded label to the partner vendor; receiving, from the partner vendor, shipment data associated with shipping of the item from the node to the destination via the selected shipping carrier; and receiving, directly from the selected shipping carrier, realtime shipping updates related to the encoded label.

The present application further describes a system comprising: an order coordination application executing on a first computer system, instructions to: provide, from an enterprise receiving an order, at least a portion of the order to a partner vendor, the order including an item being allocated to a node associated with the partner vendor, the order having a destination associated therewith; receive a shipping quote request message from the partner vendor; and provide the shipping quote request message to a carrier selection application at an enterprise fulfillment platform. The system further comprises the enterprise fulfillment platform, executing on a second computer system communicatively connected to the first computer system, instructions to: receive the shipping quote request; select at least one shipping carrier option for shipment of the item from the node to the destination, wherein the at least one shipping carrier option is selected from among a plurality of carriers based, at least in part, on realtime data associated with the plurality of carriers, wherein each of the plurality of carriers has a plurality of predefined carrier rates maintained for use by the enterprise; determine a quote associated with each of the at least one shipping carrier options, each quote being based on a selected carrier rate from among the plurality of predefined carrier rates, a location of the node, and the destination; and provide the quote to the order coordination application. Wherein, the order coordination application further executes instructions to: calculate a partner vendor quote associated with each of the at least one shipping carrier options, comprising applying an adjustment to each determined quote; provide the at least one shipping carrier options and each associated partner vendor quote to the partner vendor; receive a responsive communication from the partner vendor; and based on the responsive communication comprising a selection, by the partner vendor, of a shipping carrier of the at least one shipping carrier options, send a label request to the enterprise fulfillment platform, the enterprise fulfillment platform further executes instructions to: generate a label associated with the order; encode, at the label creation application, the label with information identifying the order as being associated with the enterprise; and provide the encoded label to the order coordination application, and the order coordination application further executes instructions to: receive the encoded label; provide the encoded label to the partner vendor; receive, from the partner vendor, shipment data associated with shipping of the item from the node to the destination via the selected shipping carrier; and receive, directly from the selected shipping carrier, realtime shipping updates related to the encoded label.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an example system wherein orders are placed for an item offered for sale at an enterprise system, and a carrier is selected to transport the item from an enterprise node or a third party partner node to a destination, according to an example.

FIG. 2 illustrates an example system for receiving item orders, selecting carriers, and generating shipping labels for items including items sourced from third party partner nodes, according to an example.

FIG. 3 illustrates an example schematic for receiving item orders, selecting carriers, and generating shipping labels for items including items sourced from third party partner nodes, according to an example.

FIG. 4 illustrates an example process for receiving item orders, selecting carriers, and generating shipping labels for items including items sourced from third party partner nodes, according to an example.

FIG. 5 illustrates example operations for providing an encoded shipping label to a third party partner vendor, according to an example.

FIG. 6 illustrates an example method for optimization of third party partner item shipments, according to an example.

FIG. 7 illustrates an example user interface for selecting a shipping carrier, according to an example.

FIG. 8 illustrates an example user interface for displaying shipping updates to a customer user, according to an example.

FIG. 9 illustrates an example block diagram of a computing system.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems, or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Historically, when an enterprise such as a retail enterprise offers items for sale by acting as an online marketplace for third party partner items, carriers would typically arrange with the third party partner for purposes of shipment, particularly in instances where the third party partner selects the carrier to be used. As such, the computer systems of the carriers selected by the third party partner provide status and tracking updates directly to the third party partner vendor. At the same time, the enterprise may offer items for sale directly to customer users as well; those customer users often have an expectation that the retail enterprise coordinates delivery of goods, and is able to provide accurate status of all ordered items – including those which are shipped directly from the third party partner. In order for the enterprise to provide shipping updates to customers and to track or gather any shipping data for internal uses, the enterprise computer systems, for example an enterprise API or other enterprise computing systems, must typically send requests to the third party partner vendor computing systems and then wait for a response including the requested status/tracking data; or must wait for such data in the absence of the request. This technological configuration results in the need for status/update messages to be sent (by the enterprise computing systems) to the third party partner computing systems, and/or the need for the enterprise computing systems to wait for the update/status data. Therefore, this technological arrangement means that the enterprise system does not receive realtime status or tracking update data from the carriers of items provided by the third party partner, and cannot internally utilize that data or provide that data to customers on a timely or realtime basis. As such, customers may have an inconsistent experience regarding receipt of shipping updates, with items stocked by the retailer being updated quickly, while items delivered to the customer directly from a third party vendor having delayed or inconsistent shipment status updates. Specifically, this historical technological arrangement results in a reliance on the third party vendor computing system, which may be technologically unsophisticated and/or incapable of handling the type and/or volume of data being received from carrier systems that needs to be routed to the enterprise systems; this may cause delay in receiving data, a lack of data received at all, and/or inaccurate/insufficient data being received.

Disclosed herein are systems and methods for providing item shipment options to third party partners, for shipment of items provided by third party partner vendor nodes via carriers with whom the enterprise has a contract. These disclosed enterprise systems and methods include technological computing systems configured to: provide the third party partner vendor with carrier options and quotes based at least in part on realtime data; based on a selection of a carrier option by the third party partner vendor, generate and encode a shipping label for the item(s) of a virtual order; and, because of the encoding of the shipping label, directly receive realtime shipping status/tracking update data for the item(s) from the carriers. The disclosed technological features provide the enterprise systems the ability to received realtime shipping status/tracking update data for third party items directly from carriers; eliminate reliance on slow or incapable third party partner vendor computing systems; and reduce or eliminate the number of shipping update data request transmissions from the enterprise system to the third party computing systems.

An enterprise that offers items for sale to be delivered to customers at a destination may be transported from an origin node to the destination through a line hauling system, which routes items from nodes to the destination, and in some examples, through intermediate sortation locations. The items may be transported along routes between locations via one or more carriers (for example, long haul carriers or last mile delivery (LMD) carriers). An example of a line hauling system is described in U.S. Patent No. 12,001,994, entitled, “Delivery management platform and mobile application,” which is incorporated herein in its entirety by reference, except for any inconsistencies. The enterprise may have contracts with a plurality of carrier services that outline prices/rates, capacities, routes, and/or other features. These contracts may include rates and other business terms that are beneficial to the enterprise and/or the carrier.

The enterprise may offer for sale and delivery (for example, for sale via an online shopping user interface, application, telephone ordering, in-store-for-delivery ordering, or ordering format) items that are shipped from an enterprise source node (e.g. an enterprise warehouse or store) to a destination specified by the ordering customer (e.g. a home or business). When an item (or plurality of items) is ordered from the enterprise and the item is sourced from an enterprise node, the enterprise allocates the order to a particular enterprise node of a plurality of enterprise nodes. A particular shipping carrier of a plurality of contracted shipping carriers is selected, and the selected shipping carrier transports the ordered item(s) from the allocated node to the destination.

In some examples, the enterprise acts as an online marketplace for third party partner items. For example, the enterprise may offer a user interface to a customer via which the customer may order items available not only from enterprise nodes, but also or alternatively items available from third party partner nodes. The disclosed systems allow third party partners to utilize the enterprise’s contracted shipping rates for carriers, while also increasing the efficiency with which the enterprise can receive and track item shipment data (and provide shipping updates to customers).

In some examples, a third party partner may receive an order for one or more items through the enterprise system. The partner will then request shipping quotes from the enterprise for the order. The enterprise generates a shipping quote, utilizing the negotiated shipping rates with different possible carriers. An enterprise carrier selection application, also referred to herein as a delivery mode optimization (DMO) system allocates orders to available nodes and potential carriers based on various factors such as costs, node data, and real-time carrier options. An example of a DMO system is described in U.S. Patent No. 11,823,117, entitled, “Delivery mode optimization in supply chain architecture,” which is incorporated herein in its entirety by reference, except for any inconsistencies. After generation of the shipping quotes, in some instances a markup is applied, and the marked-up quotes are provided to the third party partner for review. The markup process may be performed at a markup engine of the enterprise.

After quotes, (optionally, marked-up quotes) are provided to the third party partner, the partner may determine whether to agree to and select one of the carrier rate quotes provided by the retail enterprise (to utilize that enterprise’s contracted shipping rates and systems) or to select an independent option for shipping. In some examples, if the third party partner does not agree to the rates provided, they may instead ship the item with an alternative carrier that is approved by the enterprise. In some examples, if the partner agrees to the quotes provided, in response to receiving such an acceptance from the third party partner, the enterprise generates a shipping label that the partner utilizes for the item package. This requested label may be generated using an enterprise (shipping) label creation application, also referred to herein as a ship label at manifest (SLAM) application, based on real-time data. An example of a SLAM system is also described in U.S. 11,823,117, which is incorporated herein in its entirety as noted above. In some examples, the shipping label is encoded as though the item is shipped from the enterprise (e.g., as though the source location were an enterprise node location from which items are routed for shipping and ultimate delivery to a destination). This encoding allows the enterprise to directly access the shipping updates that relate to the package, without separately needing to reach out to a carrier or the third party partner computing system for update data. Once the third party partner ships the package via the selected carrier, the item order fulfillment details are provided directly to the enterprise. This allows the enterprise to more efficiently provide shipment status to internal enterprise systems, as well as to the customer user.

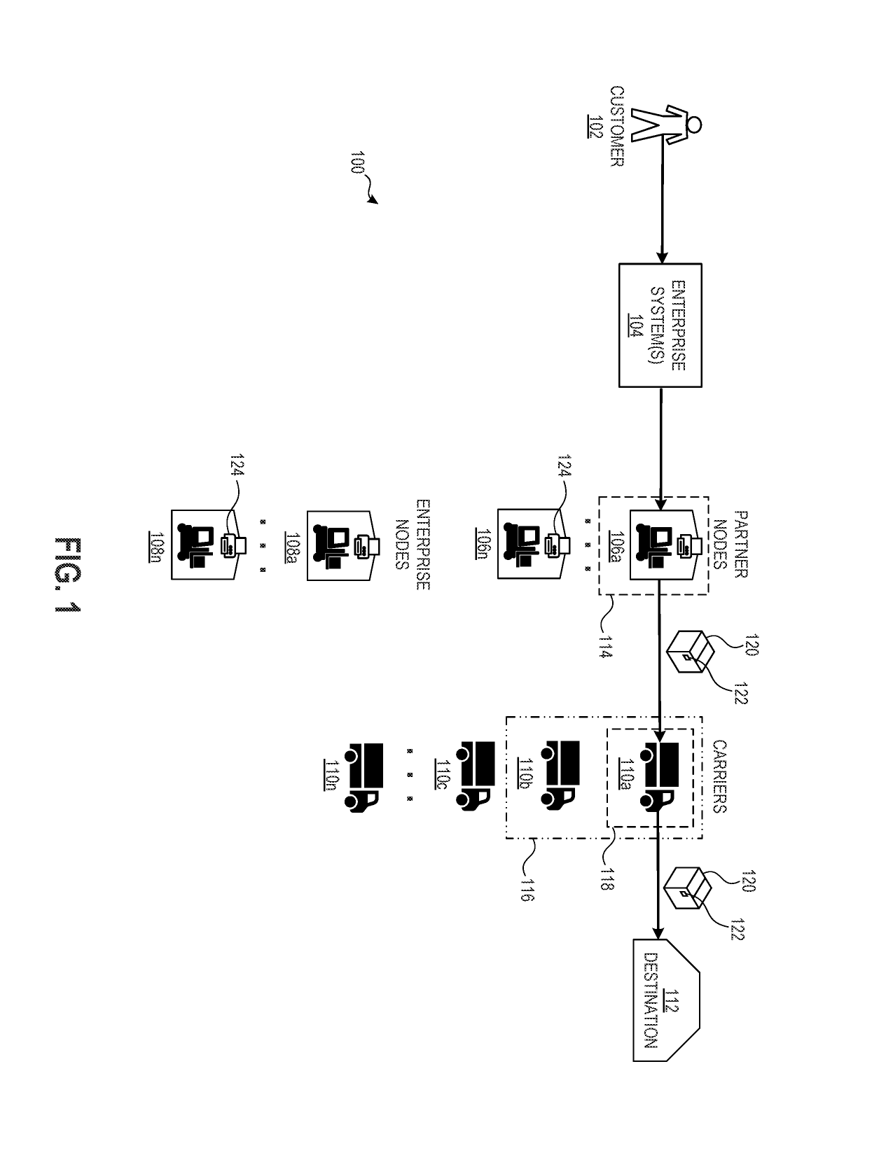

These and other examples will be explained in more detail below with respect to FIGS. 1-9.

FIG. 1 illustrates an example system 100 wherein orders are placed for an item offered for sale at an enterprise system, and a carrier is selected to transport the item from an enterprise node or a third party partner node to a destination. In some examples, a customer 102 places an order for one or more items via one or more enterprise systems 104. In an example, the enterprise may offer for sale, on an online retail site, items associated with the enterprise as well as items associated with a third party partner vendor. In some examples, the online retail site may include separate webpages (for example, separate marketplaces) where the customer 102 may view and select the enterprise items and the third party partner vendor items. In other examples, the online retail site may include the third party partner vendor items on a same webpage as the enterprise items, where the customer 102 may view and select either one or both. In examples, instead of an online retail site, the items may be similarly shown for viewing and selection on an application (for example, a mobile application).

In examples, the placed order for the one or more items is routed to one or more supply nodes that will supply (and/or otherwise coordinate the shipping of) the ordered items. In examples, nodes may include warehouses, stores, manufacturing facilities, distribution centers, consolidation centers, and other appropriate node types. In examples, a plurality of partner nodes 106a-106n are supported in the enterprise ordering system. Each of the partner nodes 106a-106n is associated with the third party partner vendor, and have the ability to supply a third party partner vendor item (e.g. serve as an item origin). In examples, a plurality of enterprise nodes 108a-108n are associated with the third party partner vendor, and have the ability to supply an enterprise item (e.g. serve as an item origin or source). Each node 106a-106n, 108a-108n may include a printer 124 configured to receive generated shipping labels from partner and/or enterprise systems, and configured to print associated physical labels for affixing to item packages to be shipped.

One or more of the enterprise systems 104 may assign/allocate each item of the customer’s 102 order to an appropriate node for fulfillment, which may include picking and packing the item for shipping. In an example, a plurality of carriers 110a-110n are available for shipment of the item from its one or more of the enterprise systems 104 may select an appropriate carrier for shipment of the item from a source node to the destination 112 (for example, a destination such as a home, business, or other location provided by the customer). Although carriers 110a-110n are depicted in the particular schematics of the Figures as a truck, a carrier may include one or more modes of transporting the item, including trucks, semi trucks, busses, vans, passenger vehicles, trains/rail transportation modes, freighters/barges/waterway transportation modes, air transportation modes, and/or other modes of transportation. In some examples, carriers 110a-110n may include private carriers, public carriers, and/or last-mile delivery carriers. In examples, the enterprise has one or more contracts with each carrier 110a-110n that define at least certain rates and/or available services. In examples, these contracts may provide advantages such as contracted rates and/or shipping times that are available to the enterprise. The enterprise systems may, in some examples, determine a subset of eligible carriers 116 from which a selected carrier 118 is ultimately determined by the enterprise (or enterprise users) or the third party partner vendor. The enterprise systems may, in some examples, determine a proposed selected carrier 118 that may be selected (or, in some examples, rejected) by the third party partner vendor. In some examples, the third party partner vendor selects a selected carrier 118.

The shipped item 120 is placed into one or more packages, each of which includes a shipping label 122 affixed thereto, which may include information such as origin node 114, destination 112, carrier 118, intermediate nodes (for example, sortation centers, distribution centers, etc.), and other information relevant for shipping and tracking of the shipped item package.

In a particular example shown, an item associated with the third party partner vendor may be allocated to (e.g. may originate from) a partner node 106a as the selected/allocated origin node 114. In the particular example, from an eligible group of carriers 116, a carrier 118 may be selected to transport the item from the origin node 114 to the destination 112. The item package 120 is provided to the selected carrier 118 at the selected node 114 for delivery to the destination 112.

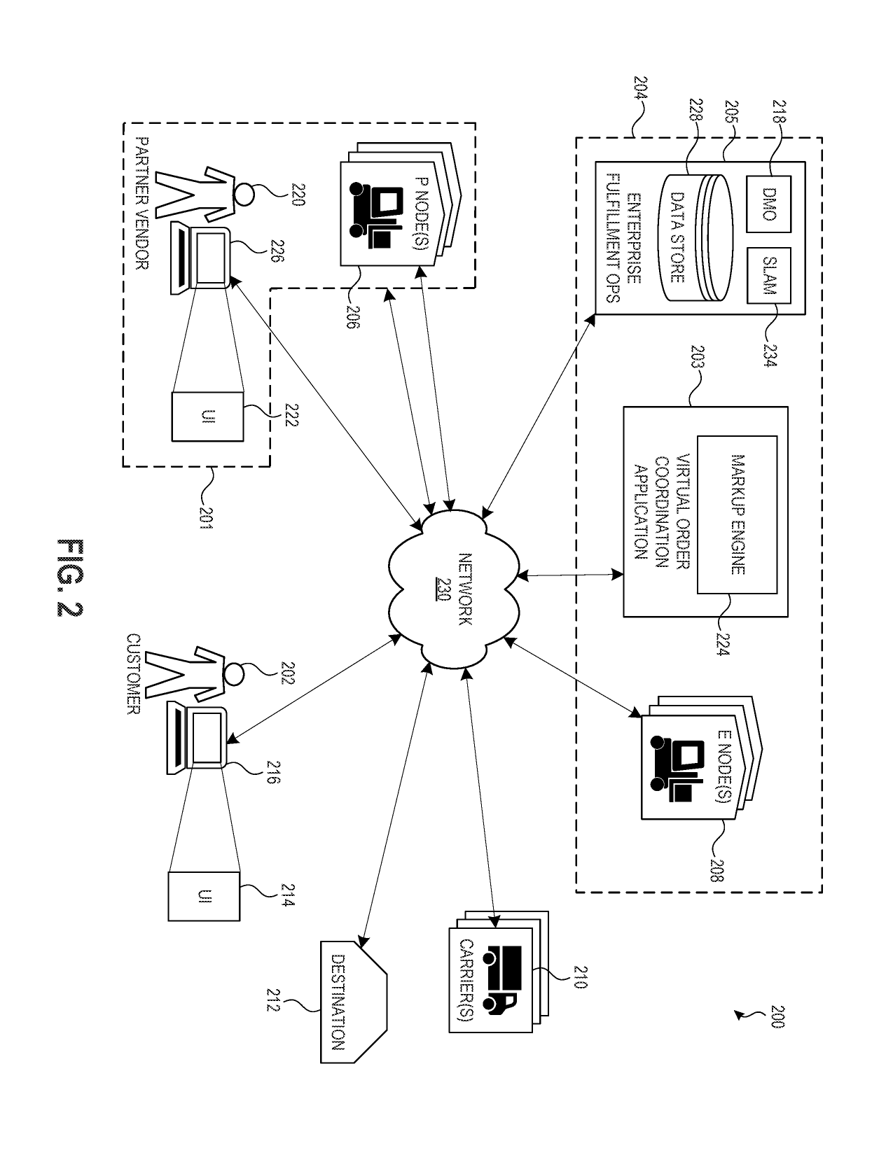

FIG. 2 illustrates an example system 200 for receiving item orders, selecting carriers, and generating shipping labels for items including items sourced from third party partner nodes. In some examples, the devices, applications, and systems of system 200 are configured to send and receive data via network 230. In some examples, as described herein, network 230 may include a computer network, an enterprise intranet, the Internet, a LAN, a Wide Area Network (WAN), wireless transmission mediums, wired transmission mediums, other networks, and combinations thereof. Although network 230 is shown as a single network in FIG. 2, this is shown as an example and the various communications described herein may occur over the same network or a number of different networks.

In some examples, enterprise systems and operations 204 may include enterprise fulfillment operations (also referred to as an enterprise fulfillment application) 205, virtual order coordination application (also referred to as an order coordination application or platform) 203, and one or more enterprise nodes 208. In some examples, third party partner vendor (herein also referred to as a partner vendor, third party partner, partner, third party, and third party vendor) 201 systems and operations 201 may include a partner vendor user 220, associated partner vendor device 226, partner user interface 222 (which may be provided to the partner vendor device 226 via one or more applications of enterprise systems 204), and one or more partner vendor nodes 206. Each of enterprise nodes 208 and partner vendor nodes 206 may include at its location a label printer (for example, printer 124) configured to receive a shipping label as described herein, and to print the physical label to be affixed to the shipped item (for example, to the box, envelope, tube, crate, or other appropriate packaging for the item) for routing and tracking of the shipped item. The shipping label may be scanned by node systems 206, 208, carrier systems 210, and/or destination systems 212 to transmit data back to the enterprise systems 204 such as virtual order coordination application 203.

In some examples, a customer user 202 (for example, a customer 102) may place a virtual order at a user interface 214 (for example, an online shopping interface or application shopping interface including a virtual shopping cart) via a device 216. In an example, user interface 214 is a web application. In other examples, user interface 214 is a device application. User interface 214 may be presented to the customer user 202 via a display of device 216. In some examples, device 216 may be a desktop computer, a laptop computer, a tablet, a cell phone or smart phone, a smart TV, a smart wearable device, or other appropriate electronic device which is capable of displaying and facilitating interaction with the user interface 214.

When the customer user 202 is viewing an item or searching for an item, user interface 214 may display both enterprise items and third party partner vendor items. In some examples, the user interface 214 may include separate pages (for example, separate marketplaces) where the customer 202 may view and select either of the enterprise items or the third party partner vendor items. In other examples, the user interface 214 may include the third party partner vendor items on a same page (e.g. marketplace) as the enterprise items, where the customer 202 may view and select either one or both. When the customer user 202 purchases one or more items via user interface 214, a virtual order for the items is created within the enterprise systems. Methods and system for order allocation are further described in U.S. Patent No. 11,514,395, entitled, “System for cost efficient order fulfillment,” which is incorporated herein in its entirety by reference, except for any inconsistencies.

Order data and associated node allocation data may be received at the virtual order coordination application 203. Virtual order coordination application 203 may include a markup engine 204, configured to receive quotes calculated at one or more enterprise fulfillment operations 205 applications and to calculate and apply a markup to the quote. Virtual order coordination 203 may also be configured to send data, such as requests for quotes and label creation, to one or more enterprise fulfillment operation 205. Virtual order coordination application 203 may be configured to receive the generated quotes and created labels from the one or more enterprise fulfillment operation 205, and to transmit associated data and requests to third party partner vendor systems 201. Virtual order coordination application 203 may further be configured to receive order fulfillment detail data from partner nodes 206 as well as enterprise nodes 208. Virtual order coordination application 203 may also be configured to receive shipment status and tracking data directly from carriers 210. Virtual order coordination application 203 is configured to link a virtual order with an associated generated, encoded shipping label so that received fulfillment, status, and tracking data associated with the shipping label can be then associated with the virtual order; this allows for enterprise systems and databases to be updated regarding virtual order updates, and for virtual order updates to also be provided to the customer user.

Enterprise fulfillment systems and operations 205 may include a DMO application 218, SLAM application 234, one or more databases/data stores 228, and other necessary applications and systems, including conductor systems. The conductor systems may include services executing within the enterprise which manage requests sent to internal applications such as the DMO application 218 and SLAM application 234 when those requests are received from entities external to the enterprise, and also control output of data to external entities. Enterprise fulfillment systems and operations 205 are configured to receive requests for quote generation (and associated carrier selection) and shipping label creation (for example, at DMO application 218 and SLAM application 234, respectively). Enterprise fulfillment systems and operations 205 are configured to transmit the generated quotes (and associated carrier selections) and generated shipping labels to the virtual order coordination application 203.

Databases described herein, such as enterprise database 228, may be of any appropriate database type, including distributed, centralized, relational/SQL, object-oriented, column-oriented, NoSQL, cloud-based, on-premises, operational, analytical, flat-file, network, graphical, time series, multi-model, and/or other database types. Although the databases described/shown herein are described as standalone databases for the purpose of illustrating the particular examples described, in some examples, the databases may be wholly or partially combined with other databases (including databases described relating to these examples and other enterprise databases) and may include other databases therein. Databases(s) 228 may receive and/or update stored data on a realtime basis, a periodic basis, and/or both realtime and periodic bases depending on the data type. Database(s) 228 may include carrier contract information such as contracted rates, service levels, zone information, timing and schedule information, carrier capacity, carrier availability, and other carrier information. Database(s) 228 or other enterprise databases may include item data, which may, in some examples, include data relating to items sold/provided by the enterprise and the third party partner vendor, including product identification information/a product identifier, size, features, categories, pricing, vendor/supplier, storage and/or shipping considerations, inventory information related to partner nodes and/or enterprise nodes, and/or other information. Database(s) 228 or other enterprise databases may include location data, which may, in some examples, include data relating to destinations and various locations/nodes of the enterprise and partner, including physical locations (e.g. address, zip code, and/or coordinates), associated carriers, node type, staffing, inventory capacity and capability, and other information. Database(s) 228 or other enterprise databases may include virtual orders, customer user profiles, received fulfillment data, shipment status data, shipment tracking data, generated quotes, markup data, marked-up quotes, generated shipping labels, linked shipping label-virtual order pairs, and other data.

Third party partner vendor systems 201 may be configured to receive data associated with a virtual order for one or more third party vendor items placed with the enterprise user interface 214, for example, from virtual order coordination application 203. The third party partner vendor systems 201 are configured to request a quote for shipping of the item(s) of the virtual order, for example, utilizing carriers with which the enterprise has contracts (including contracted rates). Third party partner vendor systems 201 are configured to receive generated quotes (including marked-up quotes) and selected carriers, and to evaluate them for selection or non-selection. In examples, selected carriers and associated quotes may be received at a partner user interface 222. By viewing and interacting with partner user interface 222 via a display of a partner user device 226, a partner vendor user 220 may select/choose an enterprise-selected carrier 210 and initiate indication of that selection to the enterprise systems 204, or may indicate selection of an independent/alternative carrier 210 to the enterprise system 204 (including, in some examples, providing information related to the selected alternative carrier to the enterprise system 204). In some examples, vendor user device 226 may be a desktop computer, a laptop computer, a tablet, a cell phone or smart phone, a smart TV, a smart wearable device, or other appropriate electronic device which is capable of displaying and facilitating interaction with the user interface 222.

Third party partner vendor systems 201 are configured to request a shipping label from the enterprise systems 204, and to receive the generated shipping label. The generated shipping label may be received at a printer at a partner node 206 for printing of a physical label. Third party partner vendor systems 201 are further configured to transmit fulfillment data to the virtual order coordination application 203, including fulfillment and pick-up by a carrier 210 selected by the enterprise or by the third party partner vendor.

Carriers 210 include systems configured to receive item package shipment requests from the enterprise systems 204 and/or partner vendor systems 201. The carriers 210 include, in some examples, scanner and/or machine-readable code reader systems (e.g., bar code, QR code, or the like), which are configured to scan or otherwise read the encoded shipping labels affixed to shipped item packages, and provide realtime package/item status and/or tracking update data to the enterprise systems 204 (for example, virtual order coordination application), even when the item package was fulfilled at a partner node 206.

Because the realtime scanned/read data is based on the encoded label, and because the virtual order coordination application 203 is configured to link the virtual order with any associated generated, encoded shipping label, the received realtime data is associated with the virtual order. The virtual order coordination application 203 and/or other enterprise systems 204 are then able to update data associated with the virtual order. This updated data may be used for analytics and operations internal to the enterprise, and/or may be provided to the customer user. The virtual order coordination application 203 and/or other enterprise systems 204 do not need to send/transmit data requests to carrier systems (or to the third party partner systems 201) to obtain accurate, realtime shipping status and/or tracking updates.

In a particular example, a customer user 202 may place an order for two items via user interface 214. The user interface 214 may be provided, for example, by the enterprise, for example as a retail website presenting a shopping interface for items offered for sale by the enterprise, as well as optionally, some items offered for sale through the enterprise by third party partner vendors. In the particular example, each of the two items correspond to items for sale by a particular third party partner vendor, and are allocated to separate partner nodes. In the particular example, the third party partner vendor chooses enterprise-selected carriers 210 for delivery of each of the two items from their respective partner node to the customer user. Because the items will originate from two separate nodes in separate packages, two shipping labels will be generated. Each shipping label will be encoded as if the items originate from an enterprise node, and are shipped from the enterprise rather than from the third party partner vendor. Each shipping label is also linked to the customer user’s 202 particular order, as tracked and managed by the enterprise. Therefore, realtime shipping status and tracking data associated with each of the two shipping labels/packages will be received directly at the enterprise systems 204, and the received realtime data for each (i.e. both) will be associated with the customer user’s 202 virtual order. The enterprise systems 204 may provide the customer user 202 (for example, at a user interface on a device 216) with order updates that includes updates relating to both items, even though they were shipped separately from two different partner nodes and via two different carrier vehicles. Additionally, the enterprise systems 204 may provide the customer user 202 with order updates for these ordered items with the same update availability “freshness” as updates regarding other ordered items that are ordered directly from the enterprise, since the enterprise will directly receive electronic shipping update data (e.g., electronic data interchange (EDI) data) from the respective carrier(s) handling shipping of those items.

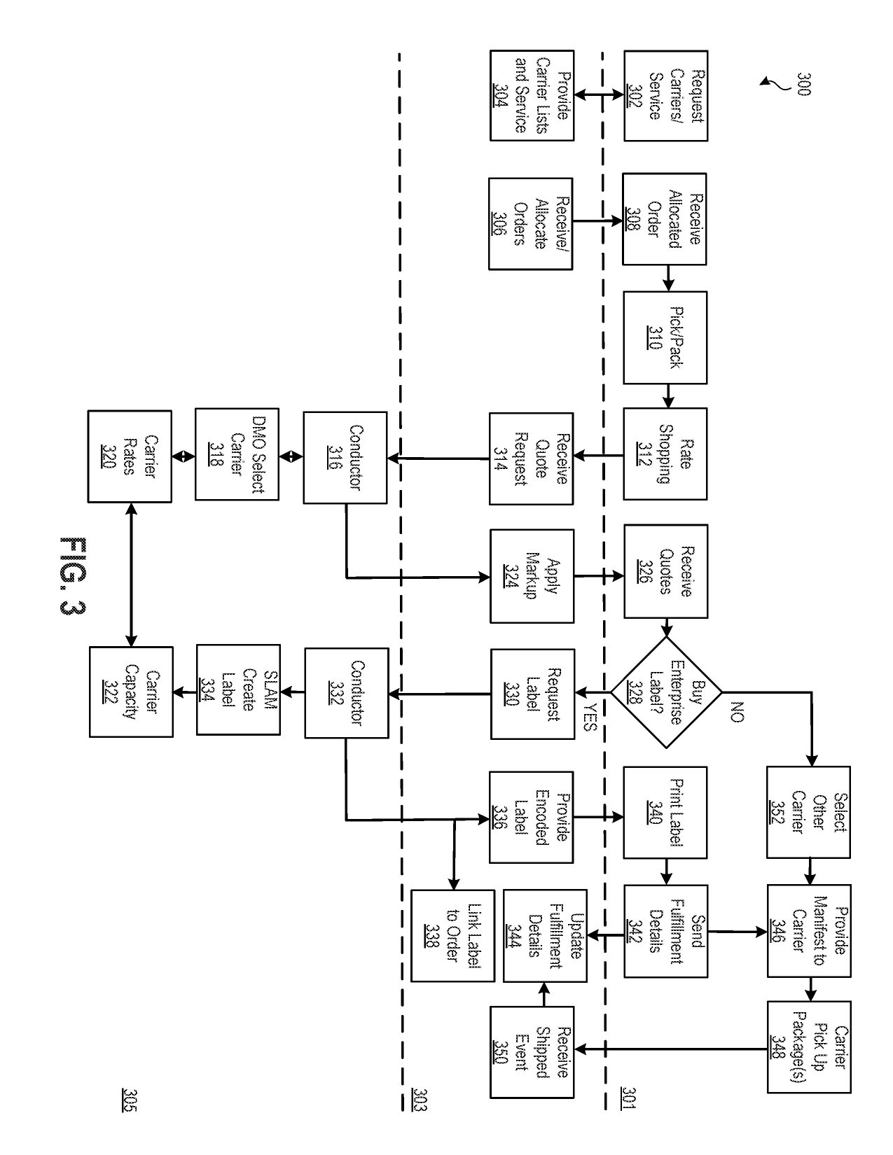

FIG. 3 illustrates an example schematic 300 for receiving item orders, selecting carriers, and generating shipping labels for items including items sourced from third party partner nodes. In an example, at an operation 302, an enterprise virtual order coordination application 303 (for example, virtual order coordination application 203) receives a request from a third party partner system 301 (for example, third party partner vendor systems 201), for carriers with which the enterprise has contracts, associated service levels and costs, and other carrier information. At an operation 304. the enterprise virtual order coordination application 303 may provide the requested data to the third party partner system 301.

At an operation 306, the enterprise virtual order coordination application 303 receives a virtual order including at least one item allocated to a third party partner vendor node. At an operation 308, the enterprise virtual order coordination application 303 transmits data associated with the items of the virtual order to the third party partner system 301, which receives the transmitted data at operation 308. Upon receipt, at an operation 310, the third party partner system 301 may pick and pack the item(s) and perform a rate shopping operation 312. At rate shopping 312, in some examples, the third party partner system 301 may evaluate rates associated with carriers with whom the enterprise does not have a contract. At rate shopping 312, in some examples, the third party partner system 301 may send a request to the enterprise virtual order coordination application 303 for a quote and carrier selection from among carriers with whom the enterprise has a contract.

At an operation 314, upon receipt of the request for quote/carrier, the enterprise virtual order coordination application 303 sends a request for quote to an application of enterprise fulfillment systems 305 (for example, enterprise fulfillment operations 305). At an operation 316, a conductor of the enterprise fulfillment systems 305 may receive the request for quotes, and provide it to a DMO application (for example, DMO application 218). At an operation 318, the DMO application selects one or more carriers associated quote(s), in some examples, by performing operations 320 and 322 to evaluate real-time carrier capacity and contracted carrier rates (for example, by accessing data stored in enterprise database 228). In an example, the DMO application provides a single selected carrier and associate quote. In some examples, the DMO application provides a plurality of potential selected carrier options and quotes associated with each. A conductor operation 316 further routes the selected carrier(s) and associated quote(s) to the enterprise virtual order coordination application 303. Upon receipt of the selected carrier(s) and associated quote(s) at a markup engine (for example, markup engine 224), at an operation 324, the markup engine applies a markup to each of the received quotes. In an example, the markup may include an amount or percentage of cost added to the quote, to account for the cost of enterprise operations over the generated quote (which is based at least in part on contracted rates and real-time data). In some examples, the markup is calculated and applied by a machine learning application. In some examples, the markup is calculated and applied by an algorithm. In some examples, the markup is calculated and applied by an enterprise user. The marked-up quote(s) and selected carrier(s) are transmitted to the third party partner system 301.

At an operation 326, the third party partner system 301 receives the marked-up quote(s) and selected carrier(s), and at operation 328, the third party partner system 301 determines whether to select one of the enterprise-provided quote(s) and selected carrier(s) or whether to select another, independent carrier.

If the third party partner system 301 selects one of the enterprise-provided quote(s) and selected carrier(s), the third party partner system 301 notifies the enterprise of its selection and requests an associated shipping label at an operation 330. At operation 330, the enterprise virtual order coordination application 303 receives the request for the shipping label associated with the selected quote/carrier, and transmits a request for generation of a shipping label to an application of enterprise fulfillment systems 305. At an operation 332, a conductor of the enterprise fulfillment systems 305 may receive the request for a shipping label, and provide it to a SLAM application (for example, SLAM application 234). At an operation 334, the SLAM application generates a shipping label associated with the selected carrier/quote, in some examples, by in accordance with operations 320 and 322. The SLAM application encodes the item as though it is originating from an enterprise node; the shipping label is encoded such that, when the shipping label is scanned or otherwise read in the future by systems associated with partner nodes, enterprise nodes, carriers, or destinations, the status and tracking data is transmitted directly to the enterprise systems (for example, enterprise virtual order coordination application 303), even when the source node is a partner node. A conductor operation 332 further routes the generated, encoded shipping label to the enterprise virtual order coordination application 303.

Upon receipt of the generated, encoded shipping label, at operation 338, the enterprise virtual order coordination application 303 links the shipping label to the associated virtual order for the item(s) to be shipped in the package that will have the physical shipping label affixed thereto. Upon receipt of the generated, encoded shipping label, the enterprise virtual order coordination application 303, at operation 336, transmits the generated, encoded shipping label to the third party partner system 301, where it may be transmitted to systems of the specific partner node to which the item(s) were allocated. The shipping label may be transmitted to a printer at the partner node, for printing (at operation 340) of the physical label to be affixed to the package for the shipped item.

Once the item(s)/package has been prepared for shipment (e.g. has been packaged with the encoded, printed label affixed), at operation 342, the third party partner system 301 transmits fulfillment data (e.g. indicating that the package is ready for shipment) to the selected carrier and to the enterprise virtual order coordination application 303. Upon receipt of the transmitted fulfillment data, at an operation 344, the enterprise virtual order coordination application 303 updates fulfillment details and status of the virtual order. The partner system 301, at operation 346, further provides a shipment manifest to the selected carrier 346. The carrier then picks up the package containing the item and with the shipping label affixed, for shipment to the destination. Once the carrier picks up the package, at operation 348, the partner system 301 transmits data to the enterprise virtual order coordination application 303 that the item package has been shipped. Upon receipt of the shipment notification event at operation 350, the enterprise virtual order coordination application 303 further updates virtual order status and fulfillment data at an operation 344.

If another carrier is selected at an operation 352, the third party partner system 301 provides a shipment manifest to the selected carrier 346. The carrier then picks up the package (which does not have an enterprise-generated, encoded shipment label affixed) for shipment to the destination. Once the carrier picks up the package, at operation 348, the partner system 301 transmits data to the enterprise virtual order coordination application 303 that the item package has been shipped. Upon receipt of the shipment notification event at operation 350, the enterprise virtual order coordination application 303 further updates virtual order status and fulfillment data at an operation 344.

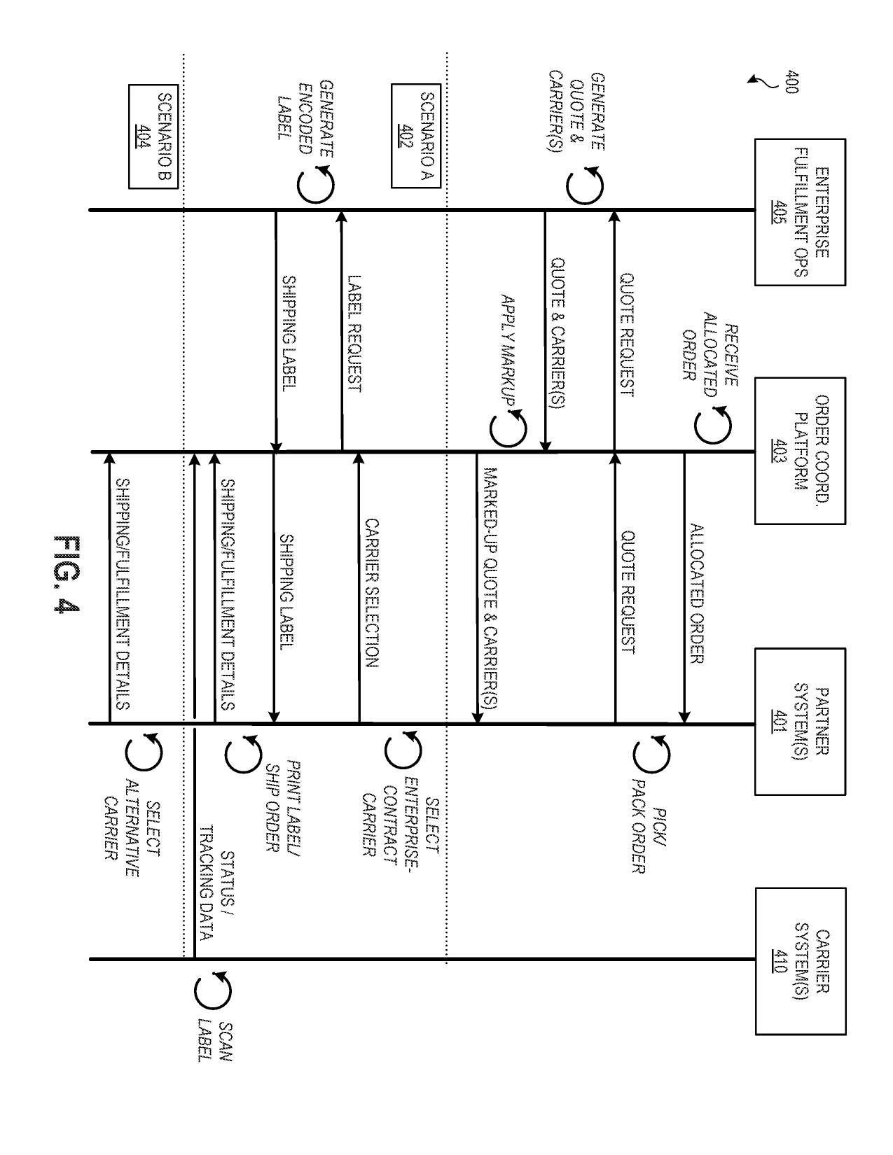

FIG. 4 illustrates an example process 400 for receiving item orders, selecting carriers, and generating shipping labels for items including items sourced from third party partner nodes. Process 400 includes the performing of calculations, determinations, and other actions at various systems, including partner system(s) 401 (for example, third party partner vendor systems 201), enterprise order coordination platform 403 (for example, virtual order coordination application 203), enterprise fulfillment operations 405 (for example, enterprise fulfillment operations 205), and carrier system(s) 410 (for example, carrier(s) 210). Process 400 includes the transmission and receipt of data between these systems. Order coordination platform 403 receives an order for an item allocated to a partner node. Order coordination platform 403 transmits the allocated order to the partner systems 401. The partner systems 401 pick and pack the order, and transmit a request for one or more quotes and associated selected carrier(s) to the order coordination platform, which formats and transmits a request for one or more quotes and associated selected carrier(s) to one or more enterprise fulfillment operations 405 systems. The enterprise fulfillment operations 405 (for example, at a DMO application) selects one or more carriers (with whom the enterprise has a contract) based at least in part on contracted rates and real time capacity data, and generates a quote for each selected carrier. The enterprise fulfillment operations 405 provides the selected carriers and associated quotes to the order coordination platform 403, which calculates and applies a markup to each quote. The order coordination platform 403 transmits the selected carriers and associated marked-up quotes to the partner systems 401. In some examples, the order coordination platform 403 generates a partner user interface (for example, such as user interface 222) whereby a partner user (for example, such as partner vendor user 220) may select one of the selected carriers, or may choose an alternative carrier not selected by the enterprise.

In a scenario A 402, the partner vendor selects one of the enterprise-selected carriers, and the partner systems 401 provides indication of the carrier selection to the order coordination platform 403 (for example, via the partner user interface). Order coordination platform formats and transmits a request for generation of a shipping label to one or more systems of enterprise fulfillment operations 405. The enterprise fulfillment operations 405 (for example, at a SLAM application) generates a shipping label in accordance with the selected carrier, contract data, and virtual order data, and encodes the shipping label (for example, as if the item package were allocated to and was originating/shipping from an enterprise node) so that future shipping status and tracking data is routed directly to enterprise systems. The enterprise fulfillment operations 405 provides the generated, encoded label to the order coordination platform 403, which further provides it to the partner systems 401. The partner systems 401 print a physical label according to the generated, encoded label, and affix the physical label to the item package when the package is prepared for shipment from the partner node via the selected carrier.

The partner systems 401 transmit shipping event and order fulfillment data to the order coordination platform 403. At various points during the shipment process of the item package, one or more carrier systems 410 may scan or otherwise read the shipping label. Because the printed shipping label is encoded as described herein, status and update data (for example, location, duration, calculated shipping and delivery times, pick-up and delivery notifications, and other data) is transmitted directly to the enterprise (for example, at order coordination platform 403) without needing to be routed through partner systems 410, even though the item package originated from a partner node and even though shipment manifests and fulfillment data may have been received by the carrier systems 410 from partner systems 401.

In a scenario B 404, the partner vendor selects an alternate carrier (e.g. a carrier that was not selected by the enterprise), and the partner systems 401 provides indication of the carrier selection to the order coordination platform 403 (for example, via the partner user interface). The partner systems prepare the item for shipment and transmit shipping event and order fulfillment data to the order coordination platform 403.

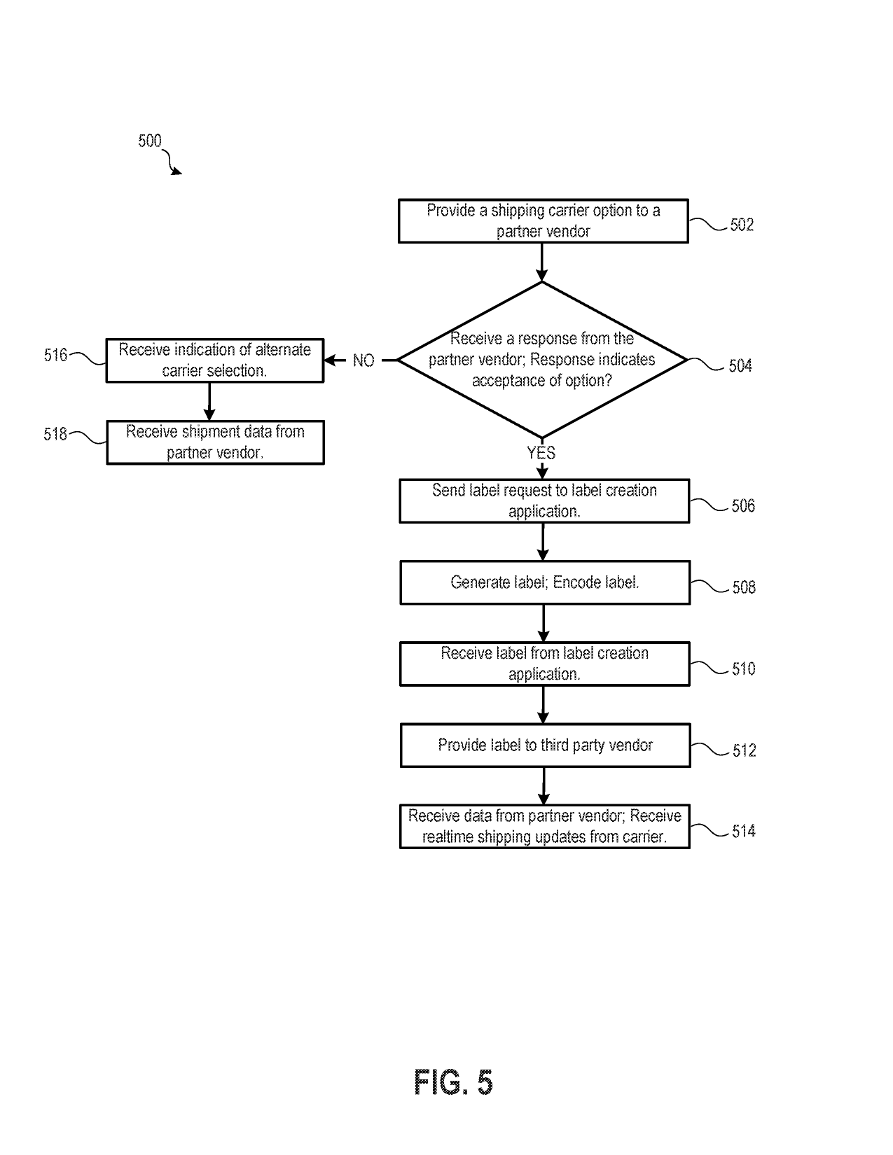

FIG. 5 illustrates example operations 500 for providing an encoded shipping label to a third party partner vendor. The operations 500 may be performed by systems described herein in FIGS. 1-4, for example, by one or more systems of the enterprise, such as an enterprise virtual order coordination application and/or enterprise fulfillment operations. At operation 502, a shipping carrier option is provided by the enterprise systems to a partner vendor system. The carrier option may have been determined by an enterprise system or application, for example, a DMO application. The carrier option may include a carrier selection, carrier information, a quote (in some examples, a marked-up quote), and/or other data. In some examples, the carrier option includes a plurality of potential carriers and associated data; in some examples, the carrier option includes one potential carrier and associated data. The carrier option relates to one or more potential carriers for shipment of at least one item of a virtual order, where the item was allocated to a node of the third party partner vendor and the enterprise has a contract with each carrier selection of the shipping option.

At operation 504, the enterprise systems receive a response from the partner vendor system. If the response indicates that the third party partner vendor has selected a carrier option provided by the enterprise system (at step 502), then the enterprise systems formats a request to a shipping label creation application of the enterprise systems (for example, a SLAM application) at operation 506. At operation 508, the shipping label creation application generates a shipping label in accordance with the information associated with the selected shipping option. The shipping label creation application encodes the shipping label as though the item was allocated to an enterprise node, even though the item has been allocated to a partner vendor node.

At operation 510, the enterprise system receives the generated, encoded shipping label from the shipping label creation application; at operation 512, the generated, encoded shipping label is provided to the third party vendor system. The encoded label is printed as a physical label and is affixed to the item package for shipment.

At operation 514, the enterprise system receives data from the partner vendor, including item/order fulfillment data and item shipment data. The enterprise system also receives realtime shipping status and/or realtime tracking updates directly from one or more carrier computing systems of the selected carrier.

Referring again to operation 504, if the response indicates that the third party partner vendor has selected a carrier option not provided by the enterprise system (at step 502), the enterprise systems do not request for an encoded shipping label to be created. The enterprise systems, at operation 516, receive indication of an alternate carrier selection. The indication may include data relating to the alternate carrier selected, for example, an identity, cost, service level, delivery time, package type, and/or other data. At operation 518, the enterprise systems receive shipment data from the partner vendor, indicating that the item has been shipped. Further, at operation 518, because the partner vendor has contracted with the carrier (instead of the enterprise contracting with the carrier), and because any shipping label on the item package is generated by the partner vendor and not generated or encoded by the enterprise, any shipping status updates from the carrier are received by the partner vendor. In order for the enterprise to receive shipping status and/or tracking updates related to the item shipment from the carrier, the enterprise either waits to receive such data from the partner vendor or transmits a request for such data from the partner vendor. In both cases, if the partner vendor supplies the shipping update data to the enterprise, the data is no longer realtime (the enterprise must wait), and the enterprise must rely on the partner vendor computer systems having adequate data processing and capacity (which may not always be the case).

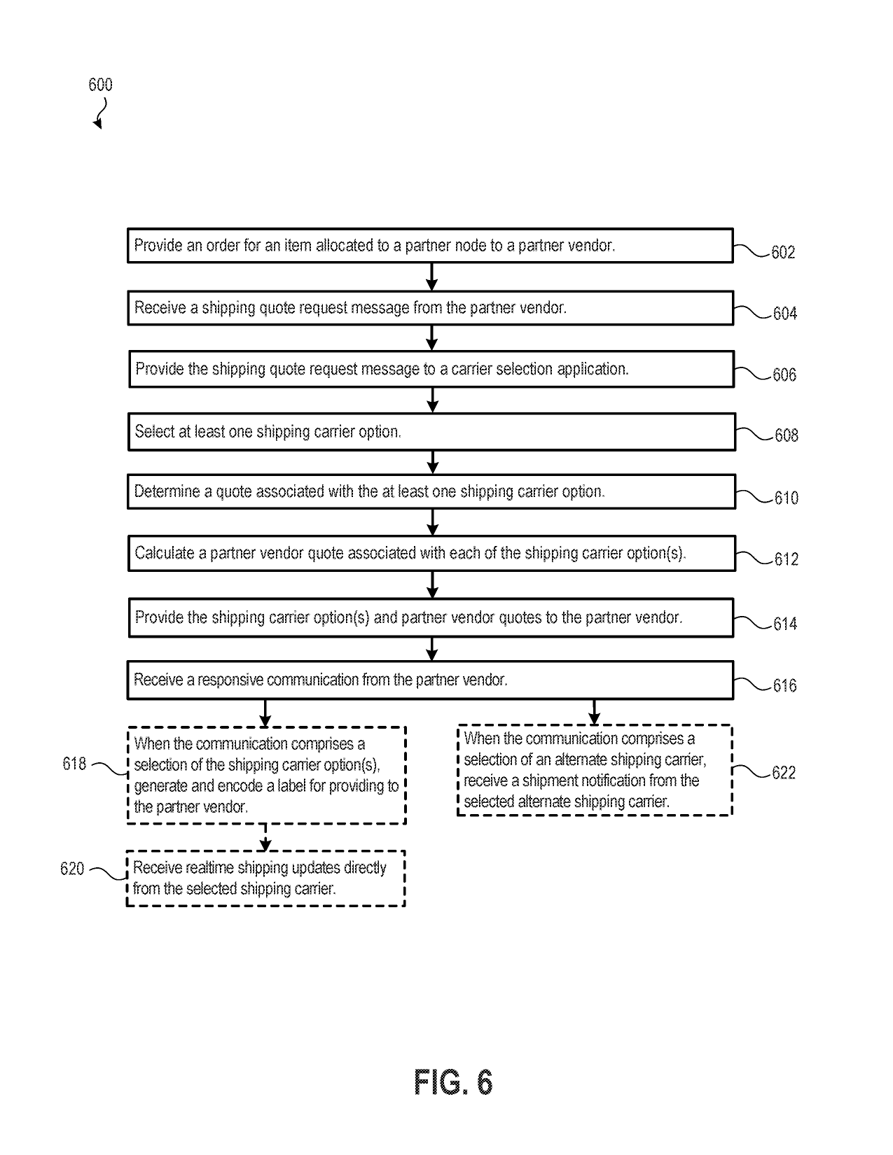

FIG. 6 illustrates an example method 600 for optimization of third party partner item shipments. At an operation 602, at least a portion of an order for an item (the item being allocated to node associated with the partner vendor) is provided, from an enterprise receiving the order, to a partner vendor. The order may have a destination associated therewith. In some examples, destination comprises a customer shipping location.

At an operation 604, a shipping quote request message is received, at an order coordination application, from the partner vendor.

At an operation 606, the shipping quote request message is provided to a carrier selection application.

At an operation 608, at least one shipping carrier option for shipment of the item from the node to the destination is selected at the carrier selection application. The at least one shipping carrier option may be selected from among a plurality of carriers based, at least in part, on realtime data associated with the plurality of carriers. Each of the plurality of carriers may have a plurality of predefined carrier rates maintained for use by the enterprise.

In some examples, the at least one shipping carrier option is selected from among the plurality of carriers based, at least in part, on a contracted rate associated with each of the plurality of carriers.

At an operation 610, a quote associated with the at least one shipping carrier options is determined at the carrier selection application. Each quote may be based, at least in part, on a selected carrier rate from among the plurality of predefined carrier rates, a location of the node, and/or the destination.

At an operation 612, a partner vendor quote associated with each of the at least one shipping carrier options is calculated at the order coordination application. The calculation of the partner vendor quote(s) may comprise applying an adjustment to each determined quote. In some examples, the quote is adapted for use by the third party vendor partner, and in some instances may be marked up or otherwise changed. Such a markup may be, for example, based on a distance between the third partner vendor node and a nearest enterprise node, or may be a further or alternative markup and/or adjustment.

At an operation 614, the at least one shipping carrier option and each associated partner vendor quote are provided, by the order coordination application, to the partner vendor. In some examples, providing the at least one shipping carrier option and each associated partner vendor quote to the partner vendor comprises generating a user interface. The user interface may comprise the at least one shipping carrier option. The generated user interface may be provided to the partner vendor.

At an operation 616, a responsive communication is received from the partner vendor. In some examples, the receiving the responsive communication may include receiving a signal of a partner vendor interaction with the generated user interface.

In some examples, at a first alternative operation 618, when the responsive communication comprises a selection of a shipping carrier of the at least one shipping carrier option, a label may be generated and encoded, and then may be provided to the partner vendor. A label request may be sent to a label creation application. The label creation application may generate a label associated with the order (or the portion of the order comprising the item). At the label creation application, the label may be encoded with information identifying the order as being associated with the enterprise. The order coordination application may receive the encoded label, and may provide the encoded label to the partner vendor.

In some examples, providing the encoded label to the partner vendor causes the generated label to be provided to a printer at the node associated with the partner vendor. In some examples, the encoded label is transmitted to a printer located at the partner vendor node. The partner vendor may print, at the printer, a physical label in accordance with the generated encoded label. The physical label may then be affixed to a package containing the item of the order. The physical label may be scanned or otherwise read throughout the shipment process to provide shipping updates (for example, including tracking, location, status, delivery, and/or other data) and/or to serve as a basis for shipment calculations such as estimated delivery dates/times, to the computing systems described herein.

In some examples, shipment data associated with shipping of the item from the node to the destination via the selected shipping carrier is received, at the shipping coordination application, from the partner vendor.

In some examples, at an operation 620, realtime shipping updates related to the encoded label are received (at the shipping coordination application, for example) directly from the selected shipping carrier.

In some examples, the encoded label may be linked to the item and to the order. The received realtime shipping updates may be associated/linked to the item and to the order. The order data may be updated based at least on the associated received realtime shipping updates. The realtime shipping updates may comprise at least one of a shipment status and/or a shipment tracking location, as well as other shipping update data as described herein.

In some examples, a shipping status request associated with the order may be received from a customer user device. A user interface presentable at the customer user device may be generated; such a user interface may include shipping status information including the realtime shipping updates.

In some examples, the order includes the item and a second item fulfilled by the enterprise from a node associated with the enterprise. In such an example, in response to the shipping status request, the user interface includes realtime shipping updates regarding both the item and the second item. The realtime shipping updates associated with the item may be received from the selected shipping carrier, and the realtime shipping updates associated with the second item may be received from a second carrier different from the selected shipping carrier.

In some examples, at a second alternative operation 622, when the responsive communication comprises an indication of a selection of an alternate shipping carrier, a shipment notification related to the order/item may be received from the selected alternate shipping carrier.

In some examples, the operations of method 600 may be executed by a computing system. The computing system may include at least one processor, and at least one memory storing computer-executable instructions, the computer-executable instructions when executed by the at least one processor causing the computing system to perform the operations of method 600. In some examples, the operations of method 600 may be executed by a plurality of computing systems communicatively connected to one another. In an example, an order coordination application of a first computing system may execute instructions to perform all or some of (or portions of) operations 602 through 606; 614 through 616; optionally, 618 through 620; and/or, optionally, 622. In such an example, an enterprise fulfillment platform of a second computing system may execute all or some of (or portions of) operations 608 through 612; and, optionally, 618.

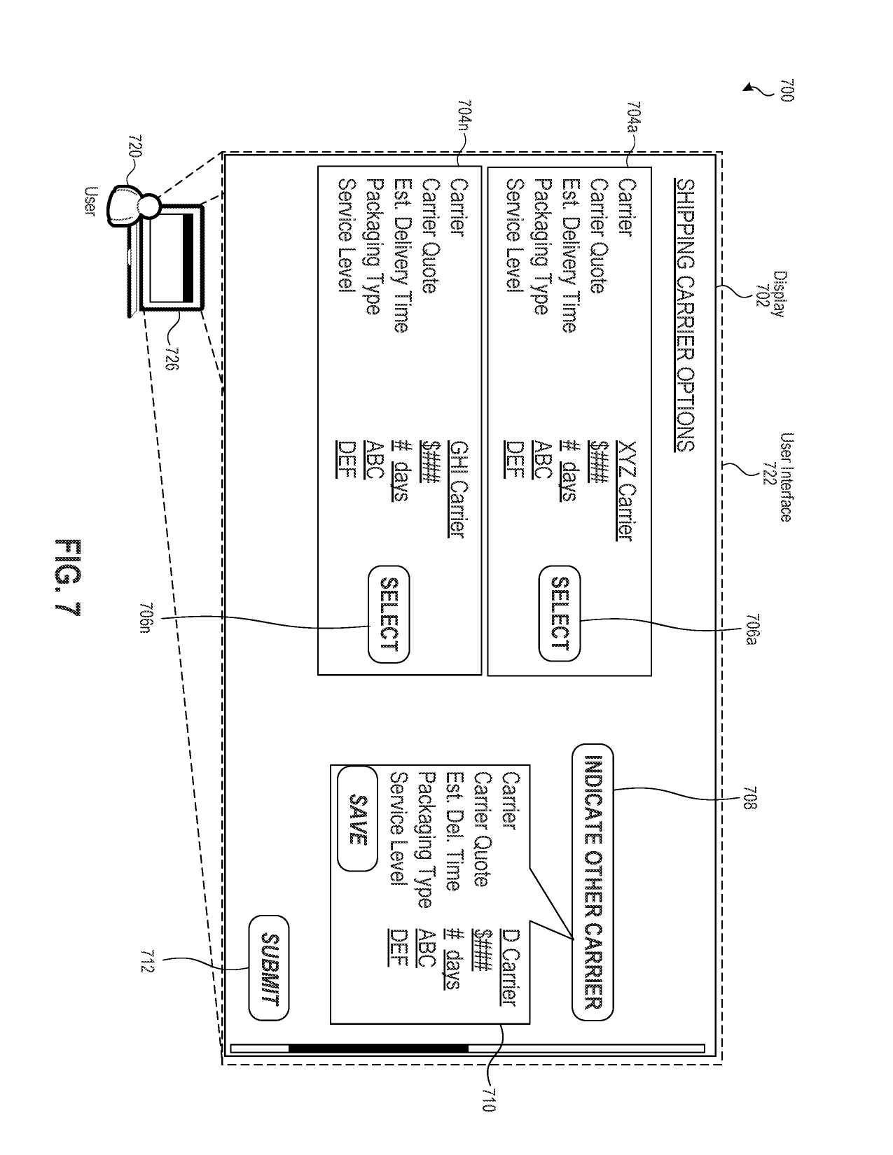

FIG. 7 illustrates an example user interface 700 for selection of a shipping carrier. In the particular example shown, a partner vendor user 720 (for example, partner vendor user 220) interacts with a partner user interface 722 (for example, partner user interface 222) on display 702 of a partner user device 726 (for example, partner user device 226). Partner user interface 722 may display one or more enterprise-provided carrier options 704a-704n for shipment of an item associated with a virtual order allocated to a partner node, along with information associated with each carrier option, to allow the partner user 720 to choose whether or not to choose one of the displayed carrier options 704a-704n. Such information may include a quote amount (for example, a marked-up quote), delivery time and/or day, packaging type, service level, and/or other information relevant to the pick-up, shipping, delivery, cost, or fulfillment of the item.

User interface 722 may include one or more interactive features 706a-706n by which a partner vendor user 720 may indicate selection of one of the user-supplied carrier options. User interface 722 may include one or more interactive features 708 by which the partner vendor user 720 may indicate selection of an alternative carrier. In some examples, an interactive feature 710 may allow the partner vendor user 720 to input information related to the alternative carrier for indication to the enterprise.

Interactive features 706a-706n, 708, 710, 712 may include one or more of buttons, toggles, checkboxes, switches, text boxes, or other features the partner vendor user 720 may interact with by mouse, keyboard, touchscreen, touchpad, joystick, voice command, stylus, or other device interaction components. Interaction with one of features 706a-706n, 708, 710, 712 may cause the partner computing systems disclosed herein to take action and/or transmit data as described herein, based on the nature of the feature interaction.

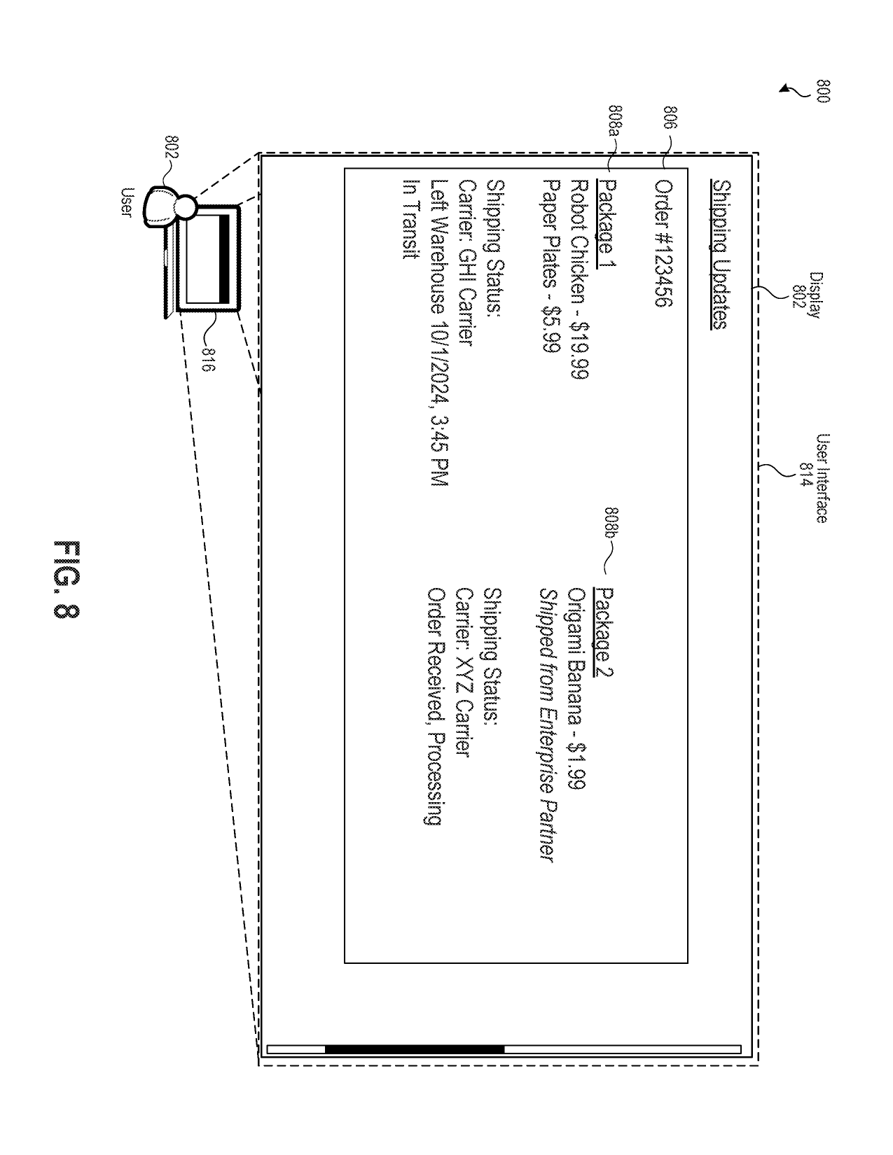

FIG. 8 illustrates a further example user interface 800 for displaying shipping updates. In the particular example shown, a customer user 802 (for example, customer 202) interacts with a customer user interface 814 (for example, user interface 214) on a display 802 of a customer user device 816 (for example, user device 216). The customer user interface 814 may present not only a web interface for conducting retail transactions, but also present, in response to an account inquiry, details regarding order status. In the specific example shown, a shipping updates screen may display the status of an order, including one or more packages that are shipped (or to be shipped) in response to placing the order. In this example, a first package status region 808a displays shipping status of a first set of one or more items included in the order, including details obtained in response to electronic data (e.g. EDI) messages received at the enterprise directly based on the enterprise conducting the shipping of those items directly to the customer user. Additionally, a second package status region 808b displays shipping status of a second set of one or more items included in the order, including details obtained directly from a carrier selected by the third party vendor in response to inclusion of an item offered by the third party vendor within the user interface of the enterprise acting as a marketplace for the third party vendor. In this instance, because of the manner of generating the shipping label as indicating that the package is shipped from the enterprise (rather than the third party vendor), the electronic data (e.g. EDI) messages from the carrier (here, XYZ carrier) are received directly at the enterprise and may be immediately available for presentation to the customer user 802 via the interface. As further details are received at the enterprise from the carrier, updated shipping information may be immediately made available to the customer user, rather than requiring that such information be separately requested from the carrier and/or the third party vendor.

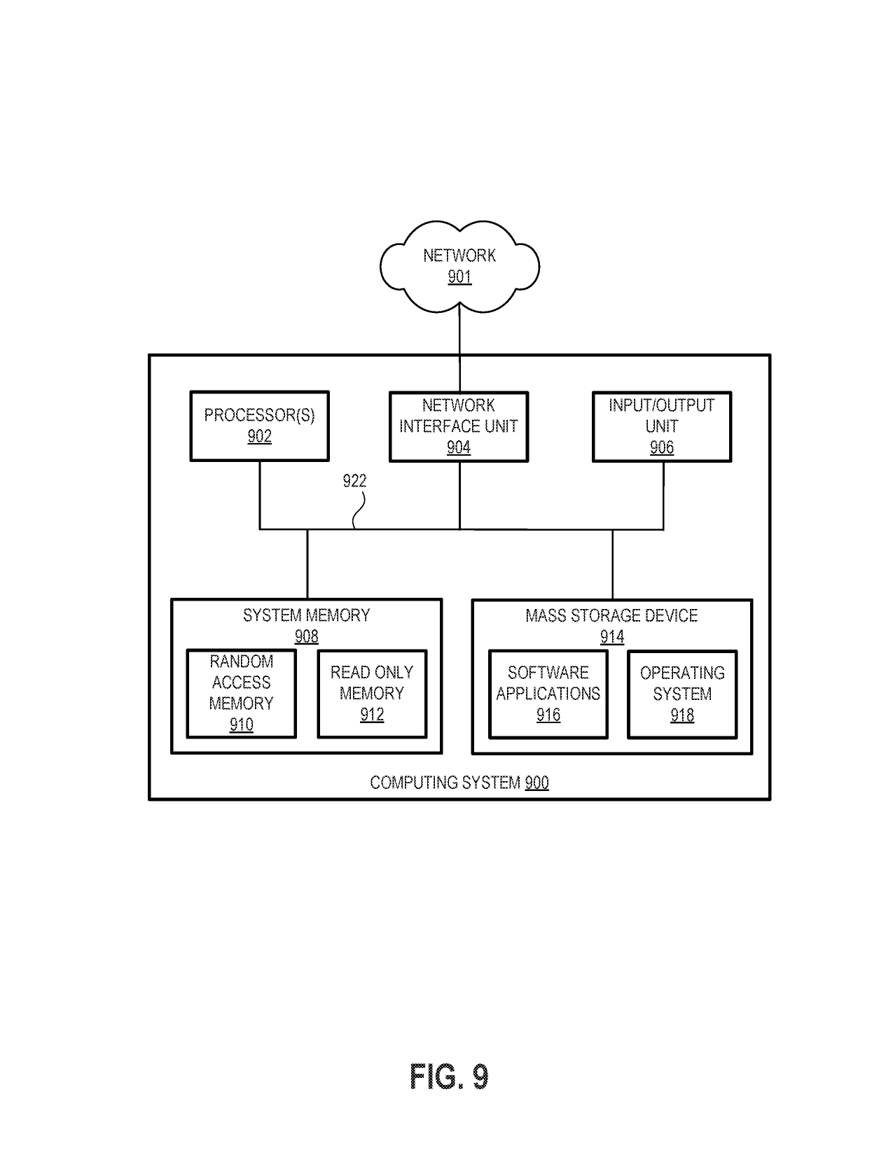

FIG. 9 illustrates an example block diagram of a virtual or physical computing system 900. One or more aspects of the computing system 900 can be used to implement the systems described herein, store instructions described herein, and preform operations described herein.

In the embodiment shown, the computing system 900 includes one or more processors 902, a system memory 908, and a system bus 922 that couples the system memory 908 to the one or more processors 902. The system memory 908 includes RAM (Random Access Memory) 910 and ROM (Read-Only Memory) 912. A basic input/output system that contains the basic routines that help to transfer information between elements within the computing system 900, such as during startup, is stored in the ROM 912. The computing system 900 further includes a mass storage device 914. The mass storage device 914 is able to store software instructions and data. The one or more processors 902 can be one or more central processing units or other processors.

The mass storage device 914 is connected to the one or more processors 902 through a mass storage controller (not shown) connected to the system bus 922. The mass storage device 914 and its associated computer-readable data storage media provide non-volatile, non-transitory storage for the computing system 900. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 900.

According to various embodiments of the invention, the computing system 900 may operate in a networked environment using logical connections to remote network devices through the network 901. The network 901 is a computer network, such as an enterprise intranet and/or the Internet. The network 901 can include a LAN, a Wide Area Network (WAN), the Internet, wireless transmission mediums, wired transmission mediums, other networks, and combinations thereof. The computing system 900 may connect to the network 901 through a network interface unit 904 connected to the system bus 922. It should be appreciated that the network interface unit 904 may also be utilized to connect to other types of networks and remote computing systems. The computing system 900 also includes an input/output controller 906 for receiving and processing input from a number of other devices, including a touch user interface display screen, or another type of input device. Similarly, the input/output controller 906 may provide output to a touch user interface display screen or other type of output device.

As mentioned briefly above, the mass storage device 914 and the RAM 910 of the computing system 900 can store software instructions and data. The software instructions include an operating system 918 suitable for controlling the operation of the computing system 900. The mass storage device 914 and/or the RAM 910 also store software instructions, that when executed by the one or more processors 902, cause one or more of the systems, devices, or components described herein to provide functionality described herein. For example, the mass storage device 914 and/or the RAM 910 can store software instructions that, when executed by the one or more processors 902, cause the computing system 900 to receive and execute managing network access control and build system processes.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures, systems, and methods shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A computing system, comprising:
at least one processor; and
at least one memory storing computer-executable instructions, the computer-executable instructions when executed by the at least one processor causing the computing system to:
provide, from an enterprise receiving an order, at least a portion of the order to a partner vendor, the order including an item being allocated to a node associated with the partner vendor, the order having a destination associated therewith;
receive a shipping quote request message from the partner vendor at an order coordination application;
provide the shipping quote request message to a carrier selection application;
select, at the carrier selection application, at least one shipping carrier option for shipment of the item from the node to the destination, wherein the at least one shipping carrier option is selected from among a plurality of carriers based, at least in part, on realtime data associated with the plurality of carriers, wherein each of the plurality of carriers has a plurality of predefined carrier rates maintained for use by the enterprise;
determine, at the carrier selection application, a quote associated with each of the at least one shipping carrier options, each quote being based on a selected carrier rate from among the plurality of predefined carrier rates, a location of the node, and the destination;
calculate, at the order coordination application, a partner vendor quote associated with each of the at least one shipping carrier options, comprising applying an adjustment to each determined quote;
provide, by the order coordination application, the at least one shipping carrier options and each associated partner vendor quote to the partner vendor; and
receive a responsive communication from the partner vendor, wherein:
when the responsive communication comprises a selection, by the partner vendor, of a shipping carrier of the at least one shipping carrier options:
send a label request to a label creation application;
generate, at the label creation application, a label associated with the order;
encode, at the label creation application, the label with information identifying the order as being associated with the enterprise;
receive the encoded label;
provide the encoded label to the partner vendor;
receive, from the partner vendor, shipment data associated with shipping of the item from the node to the destination via the selected shipping carrier; and
receive, directly from the selected shipping carrier, realtime shipping updates related to the encoded label.

2. The computing system of claim 1, further comprising instructions to:
link the encoded label to the item and to the order;
associate the received realtime shipping updates with the item and to the order; and
update order data based at least on the associated received realtime shipping updates.

3. The computing system of claim 1, wherein:
providing the at least one shipping carrier options and each associated partner vendor quote to the partner vendor comprises generating a user interface comprising the at least one shipping carrier option, and providing the user interface to the partner vendor, and
receiving the responsive communication from the partner vendor comprises receiving a signal of a partner vendor interaction with the user interface.

4. The computing system of claim 1, wherein the realtime shipping updates comprise at least one of a shipment status and a shipment tracking location.

5. The computing system of claim 1, wherein the at least one shipping carrier option is selected from among the plurality of carriers based, at least in part, on a contracted rate associated with each of the plurality of carriers.

6. The computing system of claim 1, wherein providing the encoded label to the partner vendor causes the generated label to be provided to a printer at the node associated with the partner vendor.

7. The computing system of claim 1, wherein the destination comprises a customer shipping location.

8. The computing system of claim 1, wherein the computer-executable instructions further cause the computing system to:
receive a shipping status request associated with the order from a customer user device; and
generate a user interface presentable at the customer user device including shipping status information including the realtime shipping updates.

9. The computing system of claim 8, wherein the order includes the item and a second item fulfilled by the enterprise from a node associated with the enterprise; and wherein, in response to the shipping status request, the user interface includes realtime shipping updates regarding both the item and the second item.

10. The computing system of claim 9, wherein the realtime shipping updates associated with the item are received from the selected shipping carrier, and the realtime shipping updates associated with the second item are received from a second carrier different from the selected shipping carrier.

11. The computing system of claim 1, wherein when the responsive communication comprises an indication of a selection, by the partner vendor, of an alternate shipping carrier, receive, from the selected alternate shipping carrier, a shipment notification related to the order.

12. A method, comprising:
providing, from an enterprise receiving an order, at least a portion of the order to a partner vendor, the order including an item being allocated to a node associated with the partner vendor, the order having a destination associated therewith;
receiving a shipping quote request from the partner vendor;
selecting at least one shipping carrier option for shipment of the item from the node to the destination, wherein the at least one shipping carrier option is selected from among a plurality of carriers based, at least in part, on realtime data associated with the plurality of carriers, wherein each of the plurality of carriers has a plurality of predefined carrier rates maintained for use by the enterprise;
determining a quote associated with each of the at least one shipping carrier options, each quote being based on a selected carrier rate from among the plurality of predefined carrier rates, a location of the node, and the destination;
calculating a partner vendor quote associated with each of the at least one shipping carrier options, comprising applying an adjustment to each determined quote;
providing the at least one shipping carrier options and each associated partner vendor quote to the partner vendor;
receiving a responsive communication from the partner vendor; and
based on the responsive communication comprising a selection, by the partner vendor, of a shipping carrier of the at least one shipping carrier options:
generating, at the label creation application, a label associated with the order;
encoding, at the label creation application, the label with information identifying the order as being associated with the enterprise;
providing the encoded label to the partner vendor;
receiving, from the partner vendor, shipment data associated with shipping of the item from the node to the destination via the selected shipping carrier; and
receiving, directly from the selected shipping carrier, realtime shipping updates related to the encoded label.

13. The method of claim 12, further comprising:
linking the encoded label to the item and to the order;
associating the received realtime shipping updates with the item and to the order; and
updating order data based at least on the associated received realtime shipping updates.

14. The method of claim 12, wherein:
providing the at least one shipping carrier options and each associated partner vendor quote to the partner vendor comprises generating a user interface comprising the at least one shipping carrier option, and providing the user interface to the partner vendor, and
receiving the responsive communication from the partner vendor comprises receiving a signal of a partner vendor interaction with the user interface.

15. The method of claim 12, wherein providing the encoded label to the partner vendor causes the encoded label to be provided to a printer at the node associated with the partner vendor.

16. A system comprising:
an order coordination application executing on a first computer system, instructions to:
provide, from an enterprise receiving an order, at least a portion of the order to a partner vendor, the order including an item being allocated to a node associated with the partner vendor, the order having a destination associated therewith;
receive a shipping quote request message from the partner vendor;
provide the shipping quote request message to a carrier selection application at an enterprise fulfillment platform; and
the enterprise fulfillment platform, executing on a second computer system communicatively connected to the first computer system, instructions to:
receive the shipping quote request;
select at least one shipping carrier option for shipment of the item from the node to the destination, wherein the at least one shipping carrier option is selected from among a plurality of carriers based, at least in part, on realtime data associated with the plurality of carriers, wherein each of the plurality of carriers has a plurality of predefined carrier rates maintained for use by the enterprise;
determine a quote associated with each of the at least one shipping carrier options, each quote being based on a selected carrier rate from among the plurality of predefined carrier rates, a location of the node, and the destination;
provide the quote to the order coordination application, wherein:
the order coordination application further executes instructions to:
calculate a partner vendor quote associated with each of the at least one shipping carrier options, comprising applying an adjustment to each determined quote;
provide the at least one shipping carrier options and each associated partner vendor quote to the partner vendor;
receive a responsive communication from the partner vendor; and
based on the responsive communication comprising a selection, by the partner vendor, of a shipping carrier of the at least one shipping carrier options, send a label request to the enterprise fulfillment platform,
the enterprise fulfillment platform further executes instructions to:
generate a label associated with the order;
encode, at the label creation application, the label with information identifying the order as being associated with the enterprise; and
provide the encoded label to the order coordination application, and
the order coordination application further executes instructions to:
receive the encoded label;
provide the encoded label to the partner vendor;
receive, from the partner vendor, shipment data associated with shipping of the item from the node to the destination via the selected shipping carrier; and
receive, directly from the selected shipping carrier, realtime shipping updates related to the encoded label.

17. The system of claim 16, wherein the order coordination application is configured to further execute instructions to: based on the responsive communication comprising an indication of a selection, by the partner vendor, of an alternate shipping carrier, receive, from the selected alternate shipping carrier, a shipment notification related to the order.

18. The system of claim 16, wherein the order coordination application is configured to further execute instructions to:
link the encoded label to the item and to the order;
associate the received realtime shipping updates with the item and to the order; and
update order data based at least on the associated received realtime shipping updates.

19. The system of claim 16, wherein:
providing the at least one shipping carrier options and each associated partner vendor quote to the partner vendor comprises generating a user interface comprising the at least one shipping carrier option, and providing the user interface to the partner vendor, and
receiving the responsive communication from the partner vendor comprises receiving a signal of a partner vendor interaction with the user interface.

20. The system of claim 16, wherein the instructions further cause the first computing system to:
receive a shipping status request associated with the order from a customer user device; and
generate a user interface presentable at the customer user device including shipping status information including the realtime shipping updates.
